(19) United States
(12) Patent Application Publication
(10) Pub. No.: US 2012/0287350 A1
(43) Pub. Date: Nov. 15, 2012

(54) REMOTE CONTROLLER, AND CONTROL METHOD AND SYSTEM USING THE SAME

(75) Inventors: Byung-youn Song, Suwon-si (KR); Nag-eui Choi, Suwon-si (KR)

(73) Assignee: TOSHIBA SAMSUNG STORAGE TECHNOLOGY KOREA CORPORATE, Suwon-si (KR)

(21) Appl. No.: 13/365,038

(22) Filed: Feb. 2, 2012

(30) Foreign Application Priority Data
May 11, 2011 (KR) 10-2011-0044085

(51) Int. Cl. H04N 5/44; G05B 11/01

(52) U.S. Cl. 348/734; 340/12.22; 340/12.54; 348/E05.096

(57) ABSTRACT

Provided are a remote controller, and a control method and system using the same. The remote controller controls an electronic device and includes an input unit that is disposed on a first surface of a main body and provides first and second user interfaces. A sensor unit is configured to detect a user handling of the remote controller. A control unit is configured to control a user interface environment of the input unit according to a signal detected by the sensor unit.

### CROSS-REFERENCE TO RELATED PATENT APPLICATION

This application claims the benefit of Korean Patent Application No. 10-2011-0044085, filed on May 11, 2011, in the Korean Intellectual Property Office, the disclosure of which is incorporated herein in its entirety by reference.

### BACKGROUND

1. Field

The following description relates to a remote controller and a control method and system using the same, and more particularly, to a remote controller on which user's usage is reflected, and a control method and system using the same.

2. Description of the Related Art

A remote controller is an apparatus that is used to remotely control of an electrical device, such as a television, or a radio or audio device. The remote controller performs a remote control by using various methods using, for example, infrared rays or radio waves.

The remote controller is required to enable various inputs because an apparatus to be remotely controlled may have various functions and may be complicated. For example, a conventional remote controller for controlling a television has about 20 input keys including a power key, a selection key for an image input device, a number key pad, a direction key, etc. However, due to the development of smart televisions, letter and number input functions are also required.

### SUMMARY

The following description provides a remote controller that enables various inputs corresponding to user's usage, improves user convenience, and reduces manufacturing costs, and a control method and system using the same.

In one aspect, a remote controller controls an electronic device. The remote controller includes an input unit configured to be disposed on a first surface of a main body of the remote controller and configured to comprise first and second user interfaces. The remote control also includes a sensor unit configured to detect a user handling the remote controller and outputting a signal indicative thereof. The remote control includes a control unit configured to control a user interface environment of the input unit in correspondence to the signal from the sensor unit.

The input unit comprises an input panel and a hologram layer disposed on a top surface of the input panel. The hologram layer includes a holographic pattern displaying an image corresponding to the first user interface in a first viewing direction, and displaying an image corresponding to the second user interface in a second viewing direction.

The input panel includes a touch sensor or a mechanical keyboard and includes a touch screen panel. In response to the sensor unit detecting the handling of the remote controller to be with both hands, the control unit controls the input unit to display an image corresponding to the first user interface. In response to the sensor unit detecting the handling of the remote controller to be with one hand, the control unit controls that the input unit to display an image corresponding to the second user interface.

In response to the sensor unit detecting the handling of the remote controller with both hands, the control unit provides the input unit with the first user interface. In response to the sensor unit detecting the handling of the remote controller with one hand, the control unit provides the input unit with the second user interface.

The sensor unit includes at least two sensors disposed at locations to sense the user handling the remote controller with both hands. The sensor unit also includes first and second sensors disposed on portions of a bottom surface of the remote controller facing the first surface of the main body. The sensor unit further includes third and fourth sensors disposed on opposite side surfaces of the remote controller. The sensor unit further includes third and fourth sensors disposed on opposite side surfaces of the remote controller. The sensor unit may be a touch sensor, a proximity sensor, or a pressure sensor. The remote controller also includes a direction detection sensor for detecting a direction of the remote controller. The first user interface is a QWERTY keyboard, and the second user interface is a keyboard including number keys and function keys.

The input unit includes a first input region configured to provide the first and second user interfaces and a second input region configured to provide a user interface that is not related to the handling of the remote controller by a user. The handling includes the sensor unit configured to detect a position or location of a hand or hands, to detect a user's touch, to sense an approach of a user's hand, or to detect a pressure generated by a user's hand grip on the remote controller.

In another aspect, there is provided a method of controlling an electronic device by using a remote controller. The method includes detecting a handling of the remote controller by a user. The method also includes controlling a user interface environment of an input unit to correspond to the user handling of the remote controller.

In response to detecting the user handling the remote controller with both hands, the method includes providing a first user interface to the input unit. In response to detecting the user handling the remote controller with one hand, the method includes providing a second user interface to the input unit.

The method also includes detecting the user handling using the sensor unit through a change in one or more of a resistance, an electric capacity, and an inductance. The method further includes configuring the first user interface to provide a QWERTY keyboard, and configuring the second user interface to provide a keyboard including number keys and function keys.

The handling includes detecting using the sensor unit a position or location of a hand or hands, detecting a user's touch, sensing an approach of a user's hand, or detecting a pressure generated by a user's hand grip on the remote controller.

In a further aspect, there is provided a control system including an electronic device and a remote controller for controlling the electronic device. The remote controller includes an input unit configured on a first surface of a main body and provides first and second user interfaces. The remote controller also includes a sensor unit configured to detect a user handling of the remote controller. The remote controller includes a control unit configured to control a user interface environment of the input unit based on a signal detected by the sensor unit.

The first user interface is a QWERTY keyboard, and the second user interface is a keyboard having number keys and function keys. The electronic device is a smart television.

In an aspect, there is provided a remote controller to control an electronic device, including an input unit disposed on a first surface of a main body and configured to receive an input signal from a user. The remote controller includes a sensor unit configured to detect a position, a touch, a pressure, or an approach of a hand or both hands of a user on the remote controller and output a signal indicative thereof. The remote controller includes a control unit configured to control a user interface environment of the input unit in correspondence to the signal from the sensor unit.

In a further aspect, there is provided a method of a remote controller to control an electronic device, including receiving an input signal from a user through an input unit disposed on a first surface of a main body. The method also includes detecting a position, a touch, a pressure, or an approach of a hand or both hands of a user on the remote controller and outputting a detection signal indicative thereof. The method includes controlling a user interface environment of the input unit in correspondence to the detection signal.

### BRIEF DESCRIPTION OF THE DRAWINGS

The above and other features and advantages of the following description will become more apparent by describing in detail illustrative examples thereof with reference to the attached drawings in which:

FIG. 1 is a schematic plan view of a remote controller, according to an illustrative example;

FIG. 2 is a schematic side view of the remote controller of FIG. 1;

FIG. 3 is a block diagram of a control system for the remote controller of FIG. 1;

FIG. 4 illustrates a case in which the remote controller of FIG. 1 is handled with both hands;

FIG. 5 is a view of a first user interface used in the case as illustrated in FIG. 4;

FIG. 6 illustrates a case in which the remote controller of FIG. 1 is handled with one hand;

FIG. 7 is a view of a second user interface used in the case as illustrated in FIG. 4;

FIG. 8 is a view of an example of the remote controller of FIG. 1;

FIG. 9 is a view of another example of the remote controller of FIG. 1;

FIG. 10 is a view of another example of the remote controller of FIG. 1;

FIG. 11 is a schematic plan view of a remote controller according to another illustrative aspect;

FIG. 12 is a schematic side view of the remote controller of FIG. 11;

FIG. 13 is a block diagram of a control system using the remote controller of FIG. 11;

FIG. 14 is a schematic plan view of a remote controller according to another illustrative aspect;

FIG. 15 is a block diagram of a control system using the remote controller of FIG. 14;

FIG. 16 illustrates a method executed in the remote controller described with reference to FIGS. 3, 5, and 6-10 to control an electronic device; and

FIG. 17 illustrates a method executed in the remote controller described with reference to FIGS. 3, 5, and 6-10 to control the electronic device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

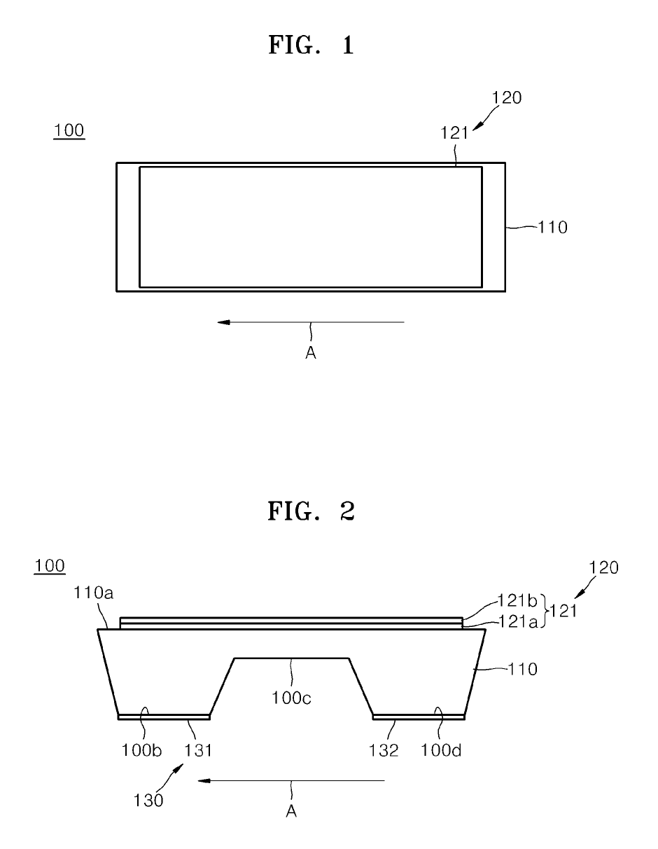

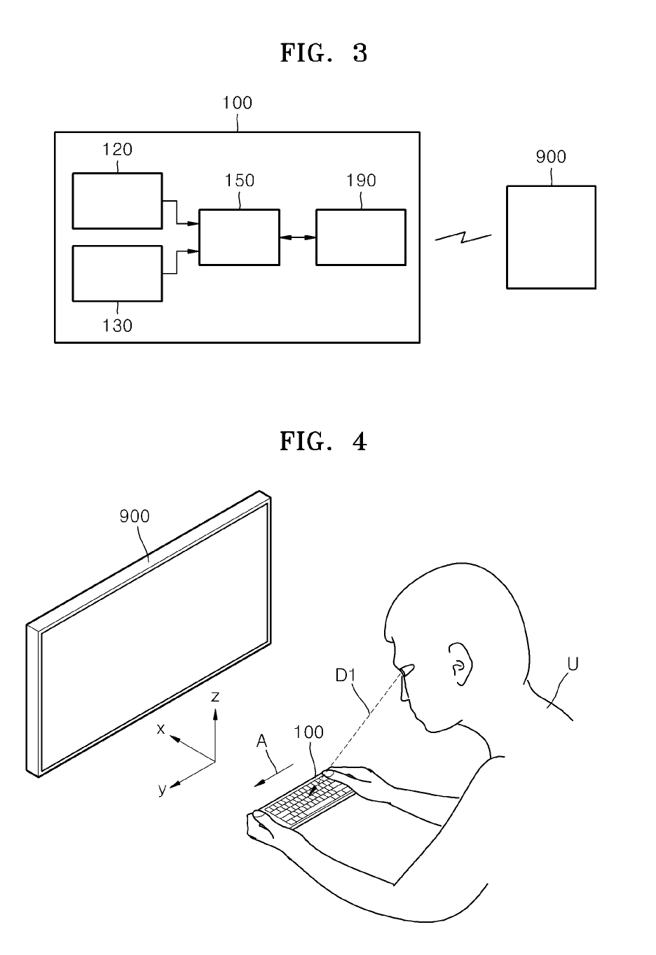

FIG. 1 is a schematic plan view of a remote controller 100 according to illustrative example. FIG. 2 is a schematic side view of the remote controller 100 of FIG. 1. FIG. 3 is a block diagram of a control system for the remote controller 100 of FIG. 1.

Referring to FIGS. 1 to 3, the remote controller 100, according to an illustrative configuration, is an apparatus configured to control an electronic device 900. The remote controller 100 includes an input unit 120 disposed on a first surface 110a of a main body 110, and a sensor unit 130 configured to sense handling. The handling may be define as the sensor unit 130 configured to detect a position or location of a hand or hands, to detect a user's touch, to sense an approach of a user's hand, or to detect a pressure generated by a user's hand grip on the remote controller 100. The remote controller 100 may also include a control unit 150 configured to control a user interface environment of the input unit 120 in correspondence to a signal detected by the sensor unit 130.

The electronic device 900 may be, for example, a smart television, an audio device, an illumination device, a game console, a cooling device, a heating device, or any other electronic product. According to another illustrative example, there may be a plurality of electronic devices 900, in which case, the remote controller 100 may selectively control the plurality of electronic devices 900.

According to an example, the main body 110 may extend in a direction A (hereinafter referred to as a lengthwise direction). Furthermore, to enhance a grip sense by a user, a center portion 110c of a bottom surface of the main body 110 facing the first surface 110a may be indented. In some cases, the main body 110 may have, for example, a rectangular shape or a streamlined shape.

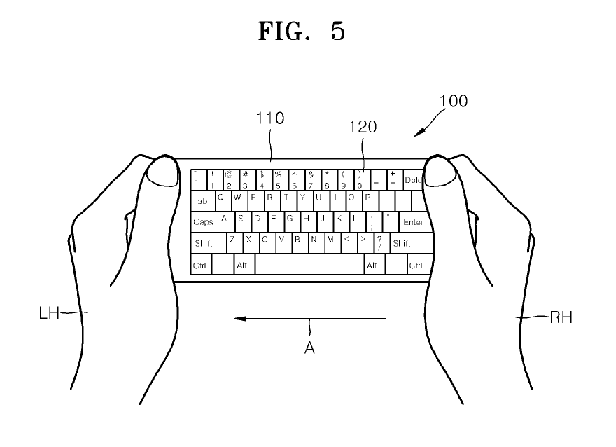

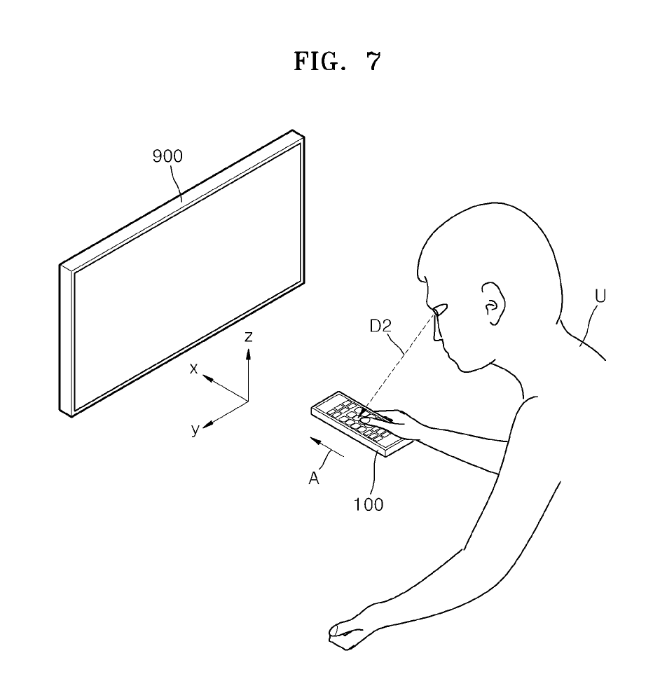

The input unit 120 may include a first input region 121 that includes an input panel 121a and a hologram layer 121b disposed on a top surface of the input panel 121a. The first input region 121 of the input unit 120 may provide at least two user interfaces. For example, a first user interface may be, as illustrated in FIG. 5, a QWERTY keyboard that is often used in a personal computer and a second user interface may be, as illustrated in FIG. 7, a keyboard having number keys and function keys. As illustrated in FIG. 7, an example of the keyboard having number keys and function keys as the second user interface is a user interface that includes a channel key, a power key, a volume key, etc. used in a remote controller for a typical television. Accordingly, when a device, such as a smart television, is to be controlled, letters are input via the first user interface of the QWERTY keyboard and channel change or volume control of a television are controlled via the second user interface, thereby improving user convenience and user friendliness.

The input panel 121a may be a touch sensor or a mechanical keyboard. In one example, the input panel 121a may be a touch sensor, in which the first or second user interface environment may be embodied in the control unit 150 by matching a coordinate value signal generated by a user's touch on the input panel 121a, with a key alignment in a user interface image shown in the hologram layer 121b. In the alternative, the input panel 121a may be a mechanical keyboard with the same number of keys and with the same key functions as in the QWERTY keyboard in the first user interface and some of the keys may function as a number key and a function key as in the second user interface.

The hologram layer 121b is a layer on which different user interface images are displayed corresponding to a user's viewing direction. If the input panel 121a is a touch sensor, the hologram layer 121b may be formed on the entire top surface of the input panel 121a. If the input panel 121a is a mechanical keyboard, the hologram layer 121b may be disposed on a top surface of each of the respective keys of the input panel 121a. As such, the hologram layer 121b may embody a plurality of user interface images at low cost.

Prior to explaining a holographic image formed on the hologram layer 121b, usage and a viewing direction of a user U will be described in detail with reference to FIGS. 4 to 7.

FIG. 4 illustrates an example in which the user U handles the remote controller 100 with both hands to manipulate the electronic device 900. In FIG. 4, a direction from the user U to the electronic device 900 is an x direction, a lateral direction of the user U is a y direction, and an upward direction is a z direction.

When the user U wants to input letters or manipulate a game, the user U may conveniently hold opposite ends of the remote controller 100 in the direction A with both hands, for example, left and right hands LH and RH, and input with thumbs thereof. As described above, when the user U handles the remote controller 100 with both hands, the lengthwise direction A of the remote controller 100 may be the lateral direction (y direction) of the user U and the user U may view the input unit 120 in a first viewing direction D1. The first viewing direction D1 may be a relative viewing direction of the user U when the lengthwise direction A of the remote controller 100 is parallel to the lateral direction (y direction) of the user U. The term ‘relative viewing direction’ means even when the user U does not move, once the remote controller 100 is moved, the viewing direction is changed.

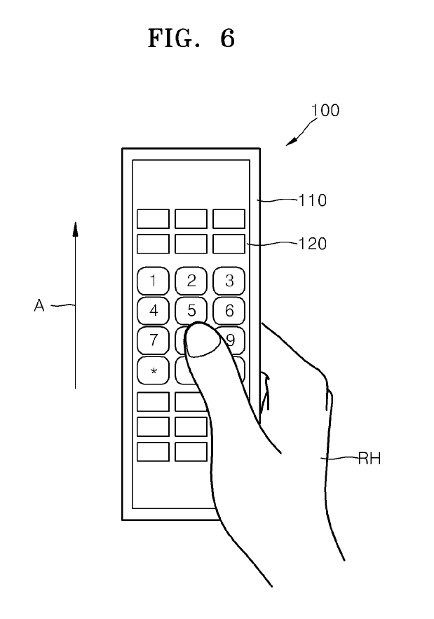

FIG. 6 illustrates a case in which the user U handles the remote controller 100 with one hand to manipulate the electronic device 900 and FIG. 5 illustrates the second user interface in this case.

Referring to FIGS. 5 and 7, like in a case with a conventional television or an audio device, the user U handles the remote controller 100 with one hand (for example, the right hand RH). In this example, the lengthwise direction A of the remote controller 100 may be toward the electronic device 900 (that is, the x direction), and the user U views the input unit 120 in a second viewing direction D2. The second viewing direction D2 may be a relative viewing direction of the user U when the lengthwise direction A of the remote controller 100 is perpendicular to the lateral direction (y direction) of the user U.

As described above, according to usage, the relative viewing direction of the user U with respect to the remote controller 100 may differ and the hologram layer 121b may form an image corresponding to a particular viewing direction. For example, the hologram layer 121b may have a holographic pattern so that in the first viewing direction D1, an image is shown corresponding to the first user interface, as illustrated in FIGS. 4 and 5. The hologram layer 121b may also have holographic pattern so that in the second viewing direction D2, an image is shown corresponding to the second user interface, as illustrated in FIGS. 6 and 7. In this case, the image corresponding to the first user interface may be an image of the QWERTY keyboard and the image corresponding to the second user interface may be an image of the keyboard having number keys and function keys.

The sensor unit 130 may sense handling as detecting a position or location of a hand or hands, detecting a user's touch, sensing an approach of a user's hand, or detecting a pressure generated by a user's hand grip on the remote controller 100. The sensor unit 130 may include first and second sensors 131 and 132 that are disposed on opposite ends of the remote controller 100 to sense or detect, for example, whether the user U is holding the remote controller 100 with both hands or one hand. For example, as shown in FIG. 2, the first sensor 131 may be disposed on a portion 110b of the bottom surface facing the first surface 110a of the main body 110, and the second sensor 132 may be disposed on a portion 110d of the bottom surface facing the first surface 110a of the main body 110.

The first and second sensors 131 and 132 may each be any type of sensor, such as a touch sensor for detecting a user's touch, a proximity sensor to sense an approach of a user's hand, or a pressure sensor to detect a pressure generated by a user's hand grip. For example, the first and second sensors 131 and 132 may each be any known touch sensor, such as a capacitive touch sensor, a resistive touch sensor, or an infrared ray-type touch sensor. Also, the user's touch may be detectable based on the magnitude of or change in impedance, such as resistance, capacitance, or reactance of the first and second sensors 131 and 132. For example, because an impedance when the user U holds the remote controller 100 with both hands may be different from an impedance when the user U holds the remote controller 100 with one hand, according to the magnitude of the detected impedance, whether the user U uses both hands or one hand may be determined. As another example, in response to the first and second sensors 131 and 132 each detecting the impedance change, the control unit 150 would process such detection as indicative that the user U is holding the remote controller 100 with both hands. In response to any one of the first and second sensors 131 and 132 detecting the impedance change, the control unit 150 would process such detection as indicative that the user U is holding the remote controller 100 with one hand.

The control unit 150 controls a user interface environment of the input unit 120 in correspondence to a signal detected by the sensor unit 130. For example, as illustrated in FIG. 5, when the user U holds the remote controller 110 with the left and right hands LH and RH and presses the input unit 120 with his or her thumbs, the left hand LH of the user U contacts the first sensor 131 of the sensor unit 130 and the right hand RH of the user U contacts the second sensor 132 of the sensor unit 130. The first and second sensors 131 and 132 sense contact. When the first and second sensors 131 and 132 detect the contact of the left and right hands LH and RH of the user U, the control unit 150 controls the user interface environment of the input unit 120 to be the first user interface which is suitable for inputting with both hands, thereby operating in a first user interface environment. If any one of the first and second sensors 131 and 132 contacts the user U, the control unit 150 controls the user interface environment of the input unit 120 to be the second user interface suitable for inputting with one hand, thereby operating in a second user interface environment.

In one aspect, when the input panel 121a is a touch sensor, the control unit 150 may match a coordinate value signal generated due to a user's touch on the input panel 121a with a key alignment through a user interface image by the hologram layer 121b, and processes a corresponding key signal of the matching keyboard to be input, thereby embodying the first or second user interface environments.

As described above, the control unit 150 may convert the first user interface into the second user interface or vice versa according to the handling of the user U detected by the sensor unit 130. Furthermore, to stop manually the control function of the control unit 150 with respect to a user interface environment, a hardware or software switch (not shown) may be additionally provided. Once the control unit 150 processes an input signal from the user U through the input unit 120, the control unit 150 transmits a control signal to the communication unit 190, which in turn transmits the control signal to the electronic device 900 through a known communication method, such as radio wave communication or infrared ray communication.

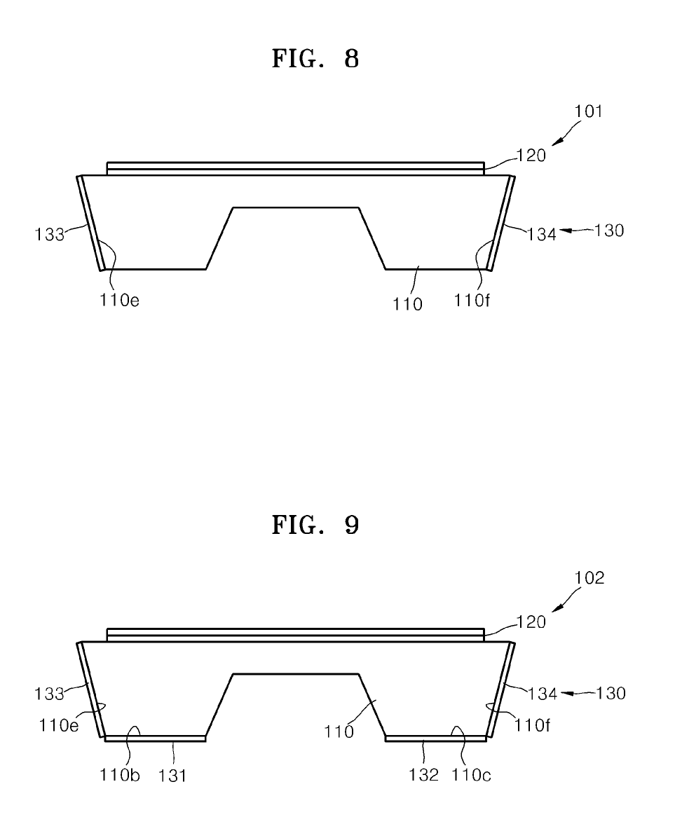

A remote controller 101 illustrated in FIG. 8 is an example of the remote controller 100. Referring to FIG. 8, the remote controller 101 according to the present embodiment is substantially identical to the remote controller 100 according to the previous example illustrated and described in FIG. 2, except for the location of the sensor unit 130. Accordingly, only the difference will be described in detail herein.

The sensor unit 130 of the remote controller 101 includes third and fourth sensors 133 and 134 respectively disposed on side surfaces 110e and 110f of the main body 110. As described above, in the case in which the usage of the user U is taken into consideration, when the user U holds the remote controller 101 with both hands, the hands of the user U may contact the side surfaces 110e and 110f of the main body 110. Also, if the user U holds the remote controller 101 with one hand, the hand of the user U may contact any one of the side surfaces 110e and 110f of the main body 110. Accordingly, the third and fourth sensors 133 and 134 may detect whether the user U uses one or two hands when handling the remote controller 101.

FIG. 9 is a view of a remote controller 102 as another example of the remote controller 100 according to the previous embodiment of FIG. 1. Referring to FIG. 9, the remote controller 102 is substantially identical to the remote controller 100 according to the previous example illustrated and described in FIG. 8, except that the sensor unit 130 further includes the third and fourth sensors 133 and 134. Accordingly, only the difference will be described in detail herein.

The sensor unit 130 of the remote controller 102 includes the first and second sensors 131 and 132 disposed on end portions 110b and 110d of the bottom surface of the main body 110, and the third and fourth sensors 133 and 134 disposed on opposite side surfaces of 110e and 110f of the main body 110. As described above, when taking the usage of the user U into consideration, the first, second, third, and fourth sensors 131, 132, 133, and 134 may all detect the user's touch and based on the signals from the sensor 130 (that is, the first, second, third, and fourth sensors 131, 132, 133, and 134, the control unit 150 determines that the user U is holding the remote controller 102 with both hands and that the input unit 120 has the environment of the first user interface, for example, the QWERTY keyboard, suitable for handling with both hands.

In another example, when only the first and third sensors 131 and 133 detect the user's touch or only the second and fourth sensors 132 and 134 detect the user's touch, it may be determined that the user U is holding the remote controller 101 with one hand and the input unit 120 has the environment of the second user interface (for example, number keys and function keys). In some cases, in response to only one of the first and third sensors 131 and 133 detecting the user's touch, the control unit 150 may determine that the first and third sensors 131 and 133 have all detected the user's touch. When only one of the second and fourth sensors 132 and 134 detects the user's touch, the control unit 150 may determine that the second and fourth sensors 132 and 134 have all detected the user's touch. By the control unit 150 making such determination, an error due to a user's incomplete handling may be corrected or taken into consideration.

In the previous examples, the sensor unit 130 may include two or four sensors. However, the number of sensors included in the sensor unit 130 is not limited thereto. For example, the sensor unit 130 may additionally include sensors on opposite ends of the top and bottom surfaces of the main body 110.

FIG. 10 is a view of a remote controller 103 as another example of the remote controller 100. Referring to FIG. 10, the remote controller 103 is substantially identical to the remote controller 100 according to the previous embodiment except that the input unit 120 further includes first and second input regions 122 and 123. Accordingly, only the difference will be described in detail herein.

The input unit 120 included in the remote controller 103 according to the present example, includes the first input region 121 to provide the first and second user interfaces that are changed corresponding to the user's handling. The remote controller 103 may also include first and second input units 122 and 123 to provide a user interface that is not related with the user's handling of the remote controller 103. An example of the first and second input units 122 and 123 is a direction key or a joystick disposed on opposite sides of the first input region 121. In other cases, the first and second input units 122 and 123 may be disposed on other regions, for example, on side surfaces of the remote controller 100, and may each be a power key, a volume key, etc.

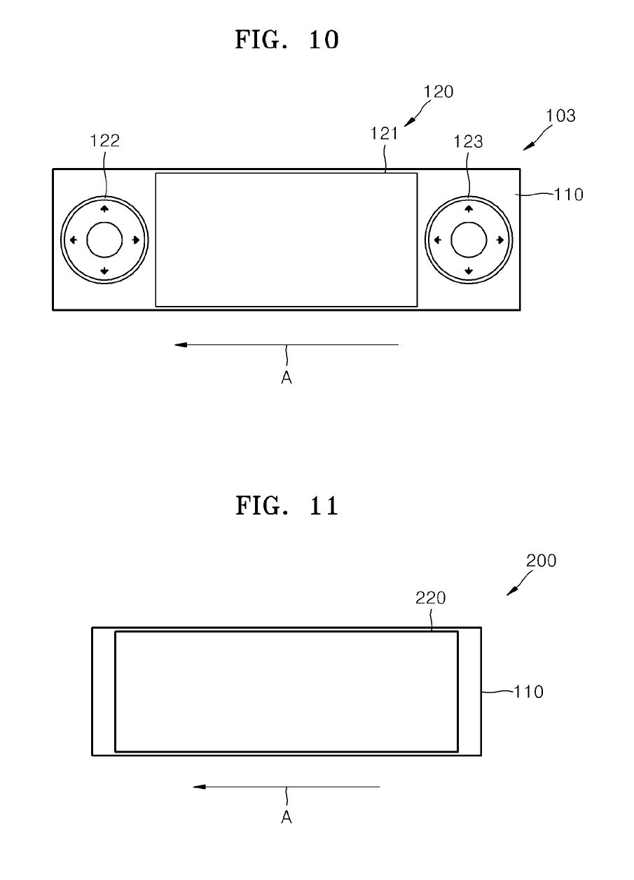

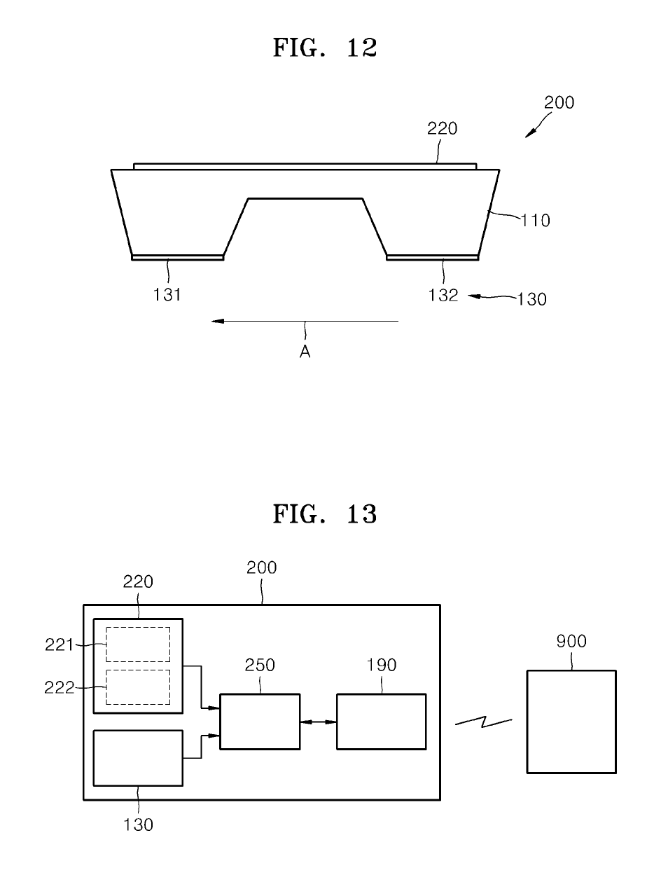

FIG. 11 is a schematic plan view of a remote controller 200 according to another illustrative example and FIG. 12 is a schematic side view of the remote controller 200 of FIG. 11. FIG. 13 is a block diagram of a control system using the remote controller 200 of FIG. 11. Like reference numerals denote like elements in FIGS. 1-13, and descriptions that have been previously presented will not be repeated herein.

Referring to FIGS. 11 to 13, the remote controller 200 includes an input unit 220 disposed on a surface of a main body 110, a sensor unit 130 for detecting handling by a user, and a control unit 250 for controlling a user interface environment of the input unit 120 in correspondence to a signal detected by the sensor unit 130.

The input unit 220 includes a touch panel unit 221 and a display unit 222. For example, the input unit 220 may be a touch screen panel in which the touch panel unit 221 and the display unit 222 have a layer structure. The touch panel unit 221 may be, for example, a capacitive touch panel, a resistive touch panel, or an infrared ray-type touch panel. The display unit 222 may be, for example, a liquid crystal panel or a organic light emitting panel. The input unit 220 or touch screen panel is well known and, thus, a detailed description thereof will not be presented herein.

The display unit 222 may display two or more user interface images according to the user's usage detected by the sensor unit 130. For example, the image of the first user interface may be an image of the QWERTY keyboard that is commonly used in a personal computer, as illustrated in FIG. 5. The image of the second user interface may be an image of a keyboard having number keys and function keys, as illustrated in FIG. 7. For example, in response to the sensor unit 130 detecting handling with both hands by a user, the display unit 222 displays the image of the first user interface, such as the QWERTY keyboard. Also, in response to the sensor unit 130 detecting handling with one hand of a user, the display unit 222 displays the image of the second user interface, such as the keyboard having number keys and function keys. Also, the control unit 250 matches a coordinate value input on the touch panel 221 with a corresponding key of the image displayed on the display unit 222, thereby embodying the first or second user interface environment.

The remote controller 200, according to an illustrative example, may be substantially identical to the remote controller 100 according to the previous embodiment, except that the input unit 220 may be a touch screen panel. Accordingly, the remote controllers 101, 102, and 103 described with reference to FIGS. 8 to 10 may also be applied to the remote controller 200.

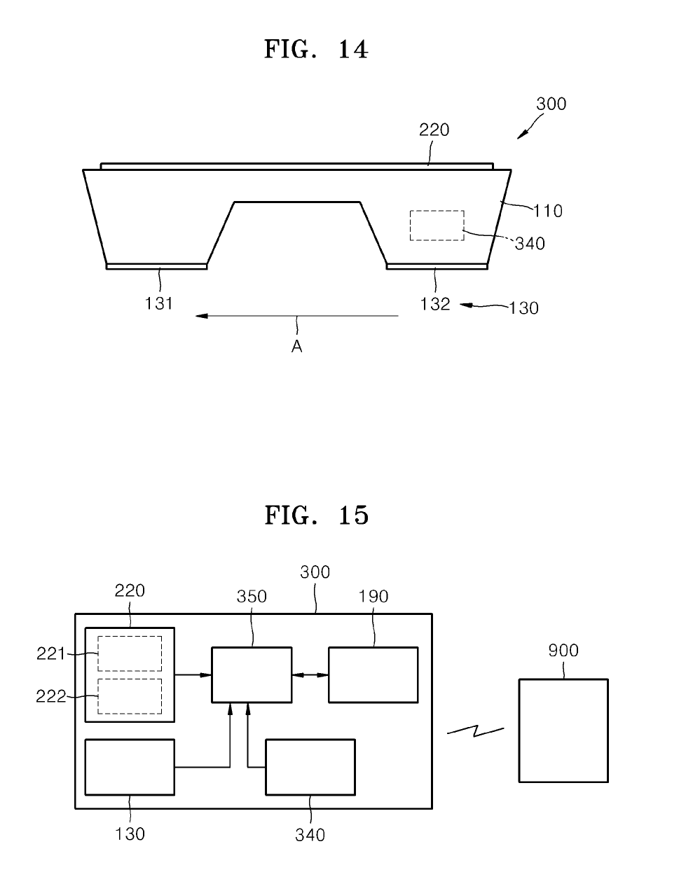

FIG. 14 is a schematic plan view of a remote controller 300, according to another illustrative example, and FIG. 15 is an example of a block diagram of a control system using the remote controller 300 of FIG. 14. Like reference numerals denote like elements in FIGS. 1-15, and descriptions that have been previously presented will not be repeated herein.

Referring to FIGS. 14 and 15, the remote controller 300, according to an illustrative example, includes an input unit 220 disposed on a surface of a main body 110 and including the touch panel 221 and the display unit 222, a sensor unit 130 configured to detect handling by a user, a direction detection sensor 340, and a control unit 350 configured to control a user interface environment of the input unit 120 in correspondence to a signal detected by the sensor unit 130 and the direction detection sensor 340.

The direction detection sensor 340 detects the direction or motion of the remote controller 300, and may include, for example, an inertial sensor, a gravity sensor, and/or a geomagnetic sensor or other similar types of sensors.

The direction or motion of the remote controller 300 detected by the direction detection sensor 340 may be taken into consideration together with information about the user's handling detected by the sensor unit 130 in determining the user's usage.

For example, when the direction detection sensor 340 is an inertial sensor, a derivation level of the remote controller 300 with respect to a reference location may be detected. The reference location may refer to a location of the remote controller 300 when a front end of the remote controller 300 faces the electronic device 900, that is, when the lengthwise direction A is toward the electronic device 900. When the front end of the remote controller 300 is derived from the reference location at an angle, for example, 45° or more toward the lateral direction of the user U, even when the sensor unit 130 detects that the user U is handling the remote controller 300 with one hand, the input unit 220 may be controlled to have the first user interface, such as the QWERTY keyboard. The input unit 220 may be controlled considering a case that the user U holds the remote controller 300 and inputs letters with one hand. Also, when the user U holds the remote controller 300 with both hands, only the user's usage detected by the sensor unit 130 is taken into consideration, regardless of the directional information of the remote controller 300 detected by the direction detection sensor 340, to determine the user interface of the input unit 220.

Furthermore, the input unit 220, according to an illustrative example, may further include, in addition to the first and second user interfaces described in the previous examples, a user interface to which information detected by the direction detection sensor 340 is reflected. For example, when the direction detection sensor 340 is a gravity sensor, whether the lengthwise direction A of the remote controller 300 extends vertically or horizontally is detectable. Accordingly, according to the vertical or horizontal orientation of the remote controller 300, the first and second user interfaces may alternate.

In the present example, the input unit 220 included in the remote controller 300 is a touch screen panel. However, the input unit 120, including the input panel 121a and the hologram layer 121b, of the remote controller 100 described with reference to FIG. 1 may also be used as the input unit 220 in the present configuration. Furthermore, the remote controllers 101, 102, and 103 described with reference to FIGS. 8, 9, and 10 according to the previous examples may further include the direction detection sensor 340.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

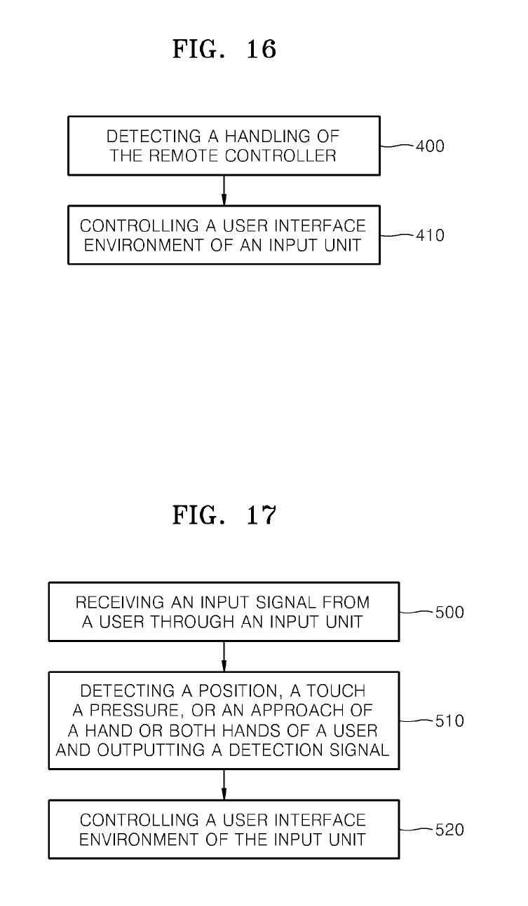

FIG. 16 illustrates a method executed in the remote controller described with reference to FIGS. 3, 5, 6-10 to control an electronic device 900. The method may include, at 400, detecting a handling of the remote controller by a user. At 410, the method includes controlling a user interface environment of an input unit to correspond to the user handling of the remote controller.

FIG. 17 illustrates a method executed in the remote controller described with reference to FIGS. 3, 5, 6-10 to control an electronic device 900. The method may include, at 500, receiving an input signal from a user through an input unit disposed on a first surface of a main body. At 510, the method includes detecting a position, a touch, a pressure, or an approach of a hand or both hands of a user on the remote controller and outputting a detection signal indicative thereof. At 520, the method includes controlling a user interface environment of the input unit in correspondence to the detection signal.

It is to be understood that in the illustrative examples, the operations in FIGS. 16 and 17 are performed in the sequence and manner as shown although the order of some steps and the like may be changed without departing from the spirit and scope of the examples described above. In accordance with an illustrative example, a computer program embodied on a non-transitory computer-readable medium may also be provided, encoding instructions to perform at least the method described in FIGS. 16 and 17.

Program instructions to perform a method described in FIGS. 16 and 17, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein may be easily construed by programmers skilled in the art to which the embodiments pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A remote controller to control an electronic device, the remote controller comprising:
an input unit configured to be disposed on a first surface of a main body of the remote controller and configured to comprise first and second user interfaces;
a sensor unit configured to detect a user handling the remote controller and outputting a signal indicative thereof; and
a control unit configured to control a user interface environment of the input unit in correspondence to the signal from the sensor unit.

2. The remote controller of claim 1, wherein the input unit comprises an input panel and a hologram layer disposed on a top surface of the input panel, and
the hologram layer comprises a holographic pattern displaying an image corresponding to the first user interface in a first viewing direction, and displaying an image corresponding to the second user interface in a second viewing direction.

3. The remote controller of claim 2, wherein the input panel comprises a touch sensor or a mechanical keyboard.

4. The remote controller of claim 1, wherein the input unit comprises a touch screen panel, and
in response to the sensor unit detecting the handling of the remote controller to be with both hands, the control unit controls the input unit to display an image corresponding to the first user interface, and
in response to the sensor unit detecting the handling of the remote controller to be with one hand, the control unit controls that the input unit to display an image corresponding to the second user interface.

5. The remote controller of claim 1, wherein in response to the sensor unit detecting the handling of the remote controller with both hands, the control unit provides the input unit with the first user interface, and in response to the sensor unit detecting the handling of the remote controller with one hand, the control unit provides the input unit with the second user interface.

6. The remote controller of claim 1, wherein the sensor unit comprises at least two sensors disposed at locations to sense the user handling the remote controller with both hands.

7. The remote controller of claim 6, wherein the sensor unit comprises first and second sensors disposed on portions of a bottom surface of the remote controller facing the first surface of the main body.

8. The remote controller of claim 7, wherein the sensor unit further comprises third and fourth sensors disposed on opposite side surfaces of the remote controller.

9. The remote controller of claim 6, wherein the sensor unit further comprises third and fourth sensors disposed on opposite side surfaces of the remote controller.

10. The remote controller of claim 1, wherein the sensor unit is a touch sensor, a proximity sensor, or a pressure sensor.

11. The remote controller of claim 1, further comprising:
a direction detection sensor for detecting a direction of the remote controller.

12. The remote controller of claim 1, wherein the first user interface is a QWERTY keyboard, and the second user interface is a keyboard comprising number keys and function keys.

13. The remote controller of claim 1, wherein the input unit comprises a first input region configured to provide the first and second user interfaces and a second input region configured to provide a user interface that is not related to the handling of the remote controller by a user.

14. The remote controller of claim 1, wherein the handling comprises the sensor unit configured to detect a position or location of a hand or hands, to detect a user's touch, to sense an approach of a user's hand, or to detect a pressure generated by a user's hand grip on the remote controller.

15. A method of controlling an electronic device by using a remote controller, the method comprising:
detecting a handling of the remote controller by a user; and
controlling a user interface environment of an input unit to correspond to the user handling of the remote controller.

16. The method of claim 15, further comprising:
in response to detecting the user handling the remote controller with both hands, providing a first user interface to the input unit, and
in response to detecting the user handling the remote controller with one hand, providing a second user interface to the input unit.

17. The method of claim 15, further comprising: detecting the user handling using the sensor unit through a change in one or more of a resistance, an electric capacity, and an inductance.

18. The method of claim 15, further comprising: configuring the first user interface to provide a QWERTY keyboard, and configuring the second user interface to provide a keyboard comprising number keys and function keys.

19. The method of claim 15, wherein the handling comprises detecting using the sensor unit a position or location of a hand or hands, detecting a user's touch, sensing an approach of a user's hand, or detecting a pressure generated by a user's hand grip on the remote controller.

20. A control system comprising an electronic device and a remote controller for controlling the electronic device, the remote controller comprising:
an input unit configured on a first surface of a main body and provides first and second user interfaces;
a sensor unit configured to detect a user handling of the remote controller; and
a control unit configured to control a user interface environment of the input unit based on a signal detected by the sensor unit.

21. The control system of claim 20, wherein the first user interface is a QWERTY keyboard, and the second user interface is a keyboard having number keys and function keys.

22. The control system of claim 20, wherein the electronic device is a smart television.

23. A remote controller to control an electronic device, comprising:
an input unit disposed on a first surface of a main body and configured to receive an input signal from a user;
a sensor unit configured to detect a position, a touch, a pressure, or an approach of a hand or both hands of a user on the remote controller and output a signal indicative thereof; and
a control unit configured to control a user interface environment of the input unit in correspondence to the signal from the sensor unit.

24. The remote controller of claim 23, wherein the control unit processes an input signal from the user through the input unit, and transmits a control signal to the electronic device.

25. The remote controller of claim 23, wherein the input unit comprises a first input region comprising an input panel and a hologram layer disposed on a top surface of the input panel.

26. The remote controller of claim 25, wherein the input panel comprises a touch sensor or a mechanical keyboard and the hologram layer comprises a layer on which different user interface images are displayed corresponding to a user's viewing direction.

28. The remote controller of claim 23, wherein the sensor unit comprises:
first and second sensors disposed on opposite ends of the remote controller to sense or detect whether the user is holding the remote controller with both hands, defining a first user interface environment, or one hand, defining a second user interface environment.

29. The remote controller of claim 28, wherein the first and second sensors each comprise one of a capacitive touch sensor, a resistive touch sensor, and an infrared ray-type touch sensor.

30. The remote controller of claim 28, wherein the first and second sensors are configured to detect an impedance change and the control unit processes the impedance change as an indication that the user is holding the remote controller with both hands.

31. The remote controller of claim 28, wherein one of the first sensor and the second sensor detects an impedance change and the control unit processes the impedance change as an indication that the user is holding the remote controller with one hand.

32. The remote controller of claim 28, wherein the sensor unit comprises third and fourth sensors disposed on side surfaces of the main body.

33. The remote controller of claim 23, wherein the sensor unit comprises first and second sensors disposed on ends of a bottom portion of the main body, and third and fourth sensors disposed on opposite side surfaces of the main body, and
wherein when the first and third sensors detect an impedance change or the second and fourth sensors detect the impedance change, the control unit processes the impedance change as the user is holding the remote controller with one hand.

34. The remote controller of claim 23, further comprising:
a direction detection sensor configured to detect a direction or motion of the remote controller, wherein the control unit is configured to control a user interface environment of the input unit in correspondence to the signal detected by the sensor unit and the direction or motion of the direction detection sensor.

35. A method of a remote controller to control an electronic device, comprising:
receiving an input signal from a user through an input unit disposed on a first surface of a main body;
detecting a position, a touch, a pressure, or an approach of a hand or both hands of a user on the remote controller and outputting a detection signal indicative thereof; and
controlling a user interface environment of the input unit in correspondence to the detection signal.
